(19) United States
(12) Patent Application Publication
(10) Pub. No.: US 2021/0048122 A1
(43) Pub. Date: Feb. 18, 2021

(54) DUCT UNIT REINFORCING METHOD

(71) Applicants: SAMIL CO.,LTD., Paju-si (KR); CATSMRO CO., LTD., Paju-si (KR)

(72) Inventor: Sang-geun HWANG, Chuncheon-si (KR)

(73) Assignees: SAMIL CO.,LTD., Paju-si (KR); CATSMRO CO., LTD., Paju-si (KR)

(21) Appl. No.: 17/086,641

(22) Filed: Nov. 2, 2020

Related U.S. Application Data
(63) Continuation of application No. PCT/KR2019/000365, filed on Jan. 10, 2019.

(30) Foreign Application Priority Data
May 3, 2018 (KR) 10-2018-0051395

(51) Int. Cl. F16L 9/04; F24F 13/02

(52) U.S. Cl. CPC F16L 9/04; F24F 13/0209

(57) ABSTRACT

The present relates a reinforcing method in which a duct reinforcement member of straight slat type is applied to a duct having a rectangular cross section whose transverse sides and longitudinal sides have changeable lengths, four bars each including a bottom open equilateral trapezoidal cross-sectional portion integrally formed with a pair of flat sheet portions extended in opposite directions under a pair of hypotenuses of the equilateral trapezoidal cross-sectional portion are bonded to four outer walls of the duct, and a curved angle coupler in contact with ends of the two bars adjacent to each other at the four corners of the duct is bonded to a pair of flat sheet portions near the ends of the two bars.

### CROSS-REFERENCE TO RELATED APPLICATIONS

This application is a continuation of International Application No. PCT/KR2019/000365 filed on Jan. 10, 2019 which claims priority to Korean Patent Application No. 10-2018-0051395 filed on May 3, 2018, the entire contents of which are herein incorporated by reference.

### TECHNICAL FIELD

The present disclosure relates to a method for reinforcing a duct unit installed in a duct of an air conditioning system of a building, and more particularly, to a duct unit reinforcing method by which it is possible to effectively support pressure applied from the inside and the outside of the body of a duct unit and the workability of installation is improved.

### BACKGROUND

A duct is installed at a plurality of locations in a structure, for example, in a ceiling of a building and forms a flow path of air and allows temperature-controlled air to flow therethrough. Such a duct is a box body manufactured by cutting and bending a steel plate.

In general, the duct is constructed to be an assembly that forms a long passage when a plurality of hollow duct bodies is connected to each other through flanges.

In general, ducts are manufactured using galvanized steel plates, galvalume steel plates or stainless steel plates with a thickness of from 0.5 mm to 1.2 mm to suppress rust, and classified into rectangular ducts and circular ducts according to their cross-sectional shape.

A rectangular duct is also called a square duct and usually manufactured by cutting and bending galvanized steel plates with a certain length, for example, from 1.8 m to 3.6 m, and joining both ends of the plates to form a body and then forming connection flanges at both ends of the duct for coupling between ducts. Therefore, a user can extend a duct to a desired length by coupling connection flanges of duct units with bolts and nuts.

Also, a circular duct is also called a spiral duct and manufactured by winding band-shaped galvanized steel plates into a circular form to form a circular cross section and continuously joining both ends of the plates in a spiral manner.

As described above, when proceeding to a final destination, a plurality of duct units may be extended by coupling or may be bent or branched from a main duct to change the direction of progress. In this state, when the duct is pressurized by a high-pressure high-speed fluid or air flowing inside the duct, vibration and noise may occur in the duct, and in severe cases, deformation may occur in the duct itself. Therefore, in order to maintain the shape of the duct and suppress noise caused by vibration, a duct reinforcement member is provided at a predetermined location of a duct unit.

Duct reinforcement members commonly used for reinforcing duct units include straight slat type and angle slat type members.

FIG. 1 is a perspective view showing a duct unit to which a duct reinforcement member of straight slat type according to a conventional technique is applied, and FIG. 2 is a perspective view showing a duct unit to which a duct reinforcement member of angle slat type according to a conventional technique is applied.

In the duct reinforcement member of straight slat type as shown in FIG. 1, a bar 20 having an L-shaped cross is cut to the same length as the width of a body 10 and fixed at a predetermined location of the body 10. The bar 20 is composed of a support 24 fixed to the body 10 and a reinforcement part 25 bent vertically from the support, and a plurality of coupling holes 22 is formed in the support 24. Accordingly, the bar 20 can be fixed to the body 10 by matching through holes 12 formed in the body 10 with the coupling holes 22 formed in the support part 24 and coupling them with rivets.

Also, in the duct reinforcement member of angle slat type as shown in FIG. 2, an angle reinforcement member 30 having an L-shaped cross section is cut to a uniform length longer than the width of the body 10 and fixed at a predetermined location of the body 10. The angle reinforcement member 30 is composed of a support 34 fixed to the body 10 and a reinforcement part 35 bent vertically from the support part, and a plurality of coupling holes 32 is formed in the support 34. Accordingly, the angle reinforcement member 30 can be fixed to the body 10 by matching the through holes 12 formed in the body 10 with the coupling holes 32 formed in the angle reinforcement member 30 and coupling them with rivets. Here, angle reinforcement members 30 adjacent to each other are cut and welded so that their ends can be exactly matched with each other, and a welded portion 38 is formed at each of the four corners.

### DISCLOSURE OF THE INVENTION

### Problems to be Solved by the Invention

In such a conventional duct reinforcement member of straight slat type, straight slats are individually coupled to the respective four sides of a square duct, and, thus, the duct reinforcement member cannot provide sufficient reinforcement to the pressure acting on the duct and cannot maintain reinforcement particularly for the pressure applied in a diagonal direction of the duct. Further, since the body and the bar of the duct reinforcement member of straight bar type are coupled to each other with rivets, a gap is formed between these coupling portions and airtightness cannot be maintained. Thus, a sealing material is applied to fill this gap, which results in a poor efficiency of installation work. Furthermore, if an insulation sheet is covered on the body of the duct to keep the duct warm, the reinforcement part of the bar protrudes vertically from the body. Therefore, the insulation sheet may be torn by both pointed ends of the reinforcement part and thus may not keep the duct warm well. In addition, the insulation sheet is formed thick for insulation, and, thus, the insulation sheet cannot be in close contact with the body and the bar of the duct and an air layer is formed between a body portion of the duct coupled to the bar and the insulation sheet, which causes condensation. Therefore, the insulation sheet may hold water therein and thus may sag downwards or waterdrops may fall to the floor of a building.

Also, in the duct reinforcement member of angle slat type, the angle reinforcement member is cut to fit the length of the four sides of the duct and adjacent angle reinforcement members need to be welded, which takes a lot of time. Further, the angle reinforcement member is expensive. Further, in the duct reinforcement member of angle slat type, the body and the angle reinforcement member of the duct are coupled to each other with rivets, and, thus, a gap is formed between these coupling portions and airtightness cannot be maintained. Thus, a sealing material is applied to fill this gap, which results in a poor efficiency of installation work. Furthermore, if an insulation sheet is covered on the body of the duct to keep the duct warm, the reinforcement part of the angle reinforcement member protrudes vertically from the body. Therefore, the insulation sheet may be torn by a pointed bent portion of the reinforcement part and thus may not keep the duct warm well. In addition, the insulation sheet is formed thick for insulation, and, thus, the insulation sheet cannot be in close contact with the body and the angle reinforcement member of the duct and an air layer is formed between a body portion of the duct coupled to the angle reinforcement member and the insulation sheet, which causes condensation. Therefore, the insulation sheet may hold water therein and thus may sag downwards or waterdrops may fall to the floor of a building.

The present disclosure has been made to solve the above-described problems.

### Means for Solving the Problems

The present disclosure can solve the above-described problems by a reinforcing method in which a duct reinforcement member of straight slat type is applied to a duct having a rectangular cross section whose transverse sides and longitudinal sides have changeable lengths, four bars each including a bottom open equilateral trapezoidal cross-sectional portion integrally formed with a pair of flat sheet portions extended in opposite directions under a pair of hypotenuses of the equilateral trapezoidal cross-sectional portion are bonded to four outer walls of the duct, and a curved angle coupler in contact with ends of the two bars adjacent to each other at the four corners of the duct is bonded to a pair of flat sheet portions near the ends of the two bars.

### Effects of the Invention

According to the present disclosure, four bars are integrally coupled to four sides of a duct as described above and thus can sufficiently reinforce the pressure acting on the duct and can maintain reinforcement particularly for the pressure applied in a diagonal direction of the duct. Also, the bars are coupled to the duct with an adhesive, and, thus, a gap is not formed between these coupling portions and the efficiency of installation work is improved. Further, if an insulation sheet is covered on the duct to keep the duct warm, ends of the bars are coupled by a curved angle coupler in a state where the bars protrude at an obtuse angle of inclination from the duct, and, thus, there is no need to worry about tearing of the insulation sheet and the insulation sheet can keep the duct warm well. Also, even if the insulation sheet is formed thick for insulation, the insulation sheet can be in close contact with the duct and the bars. Therefore, an air layer is not formed between the duct coupled to the bars and the insulation sheet, and, thus, it is possible to suppress condensation.

### BRIEF DESCRIPTION OF THE DRAWINGS

FIG. 1 is a perspective view showing a duct unit to which a duct reinforcement member of straight slat type according to a conventional technique is applied.

FIG. 2 is a perspective view showing a duct unit to which a duct reinforcement member of angle slat type according to a conventional technique is applied.

FIG. 3 is a perspective view showing a duct unit to which a duct reinforcement member according to an embodiment of the present disclosure is applied.

FIG. 4A illustrates a coupling between a slat and an angle coupler of FIG. 3.

FIG. 4B illustrates a coupling between a slat and an angle coupler of FIG. 3.

FIG. 5A illustrates a sequential process for bonding the slat of FIG. 3 to a body.

FIG. 5B illustrates a sequential process for bonding the slat of FIG. 3 to a body.

FIG. 5C illustrates a sequential process for bonding the slat of FIG. 3 to a body.

FIG. 5D illustrates a sequential process for bonding the slat of FIG. 3 to a body.

FIG. 5E illustrates a sequential process for bonding the slat of FIG. 3 to a body.

FIG. 6A illustrates a sequential process for bonding and fixing the angle coupler of FIG. 3 to the slat of FIG. 3.

FIG. 6B illustrates a sequential process for bonding and fixing the angle coupler of FIG. 3 to the slat of FIG. 3.

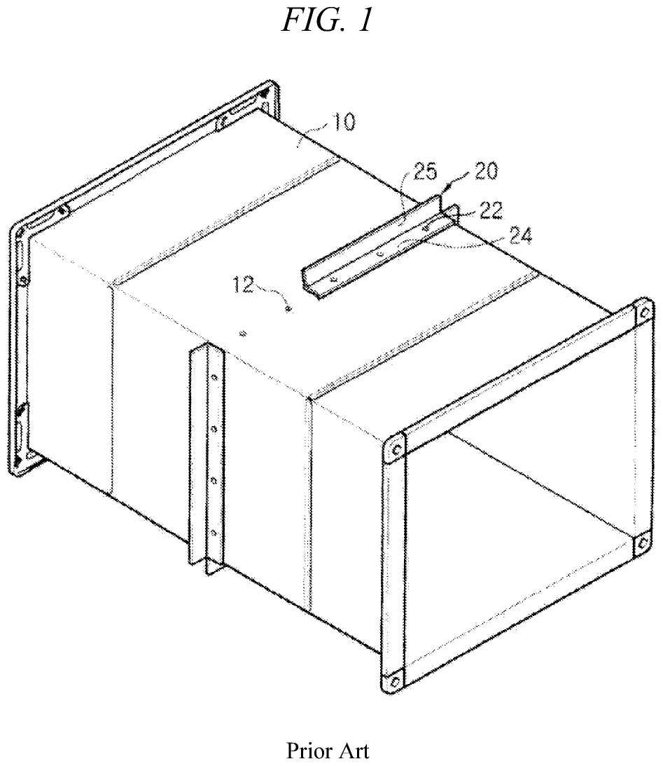

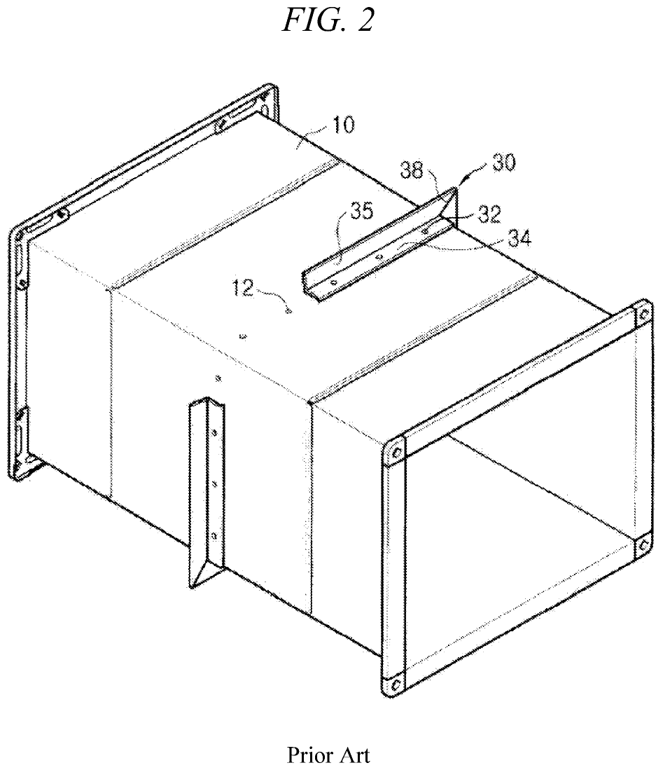

### DETAILED DESCRIPTION

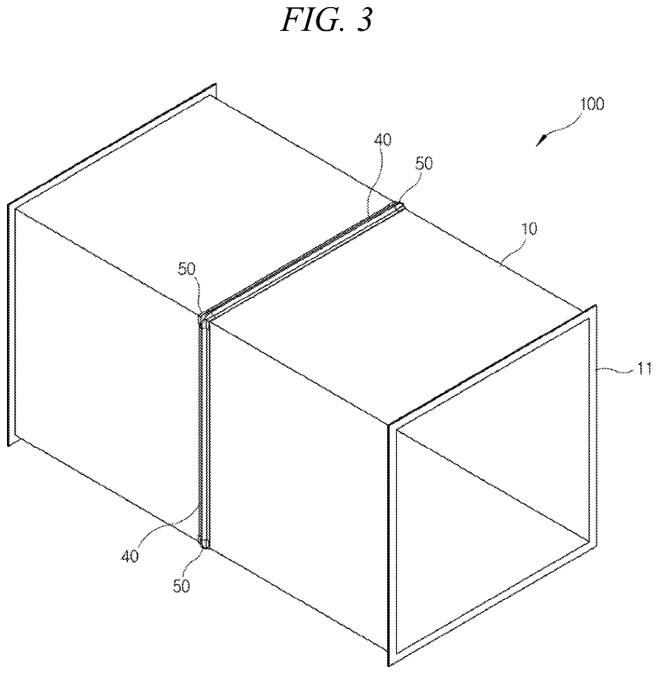

Hereinafter, a method for reinforcing a duct unit according to the present disclosure will be described in detail with reference to FIG. 3.

In FIG. 3, a duct unit is denoted by reference numeral 100.

The duct unit 100 includes a body 10 having a rectangular cross section whose transverse sides and longitudinal sides have changeable lengths by cutting and bending galvanized steel plates, galvalume steel plates or steel plates with a length of from 1.8 m to 3.6 m and joining both ends of the plates, a pair of connection flanges 11 provided at both ends of the body 10 to couple the bodies 10 to each other, four slats 40 made of metal and bonded and fixed using an adhesive to outer surfaces of the bodies 10 with the pair of connection flanges 11 interposed therebetween, and four angle couplers 50 which are resin injection-molded products in contact with ends of the two slats adjacent to each other at the four corners of the body 10 and bonded and fixed to outer surfaces of the ends of the two slats 40 using an adhesive.

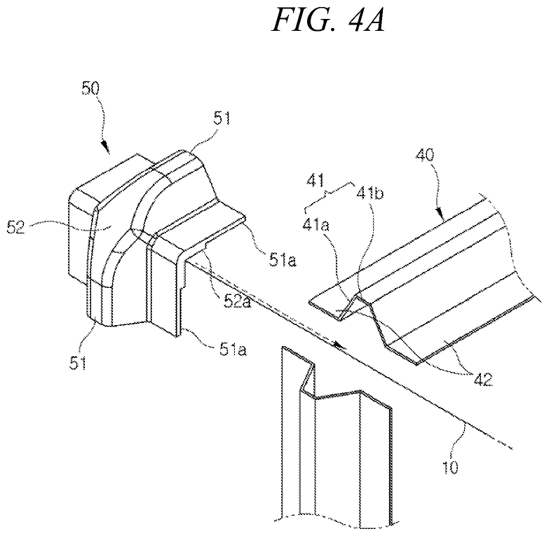

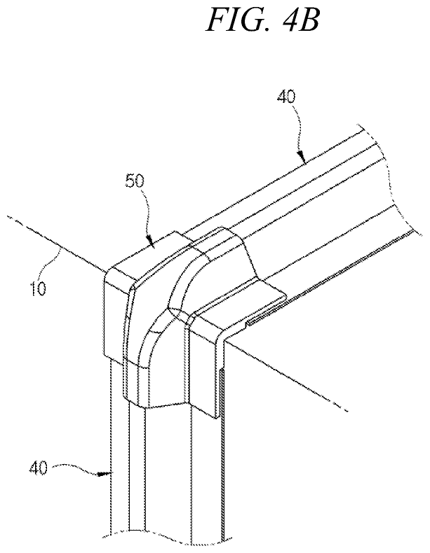

As shown in FIGS. 4A and 4B, the slat 40 includes a bottom open equilateral trapezoidal cross-sectional portion 41 integrally formed with a pair of flat sheet portions 42 extended in opposite directions under a pair of hypotenuses 41a of the equilateral trapezoidal cross-sectional portion 41.

The pair of flat sheet portions 42 has a width greater than the width of an upper side 41b of the equilateral trapezoidal cross-sectional portion 41 and smaller than the width of the pair of hypotenuses 41a, and bent 120 degrees from the pair of hypotenuses 41a.

Further, as shown in FIGS. 4A and 4B, the angle coupler 50 includes a pair of female parts 51 which have the same section width as the section width of the slat 40 and are stacked on the ends of the two slats 40 to be in contact therewith and bonded and fixed to the ends of the two slats 40 and a bent part 52 whose both ends are integrally coupled to the pair of female parts 51 and middle inner side has a 90-degree bent surface and middle outer side has a three-dimensional bent surface.

In bottom surfaces of the pair of female parts 51, a step portion 51a is formed to be mounted on the pair of sheet portions 42 of the slat 40, and in a bottom surface of the bent part 52, a L-shaped bump portion 52a is formed to prevent the pair of flat sheet portions 42 from exceeding the L-shaped bump portion 52a.

The bump portion 52a has a size by which a bottom surface of the bump portion 52a cannot be in contact with the body 10 when the angle coupler 50 is coupled to the slat 40.

The reason for this is to allow a clearance taking into account that if the corner of the body 10 is bent 90 degrees with a tolerance, the step portion 51a of the angle coupler 50 may not be mounted on the pair of sheet portions 42 of the slat 40.

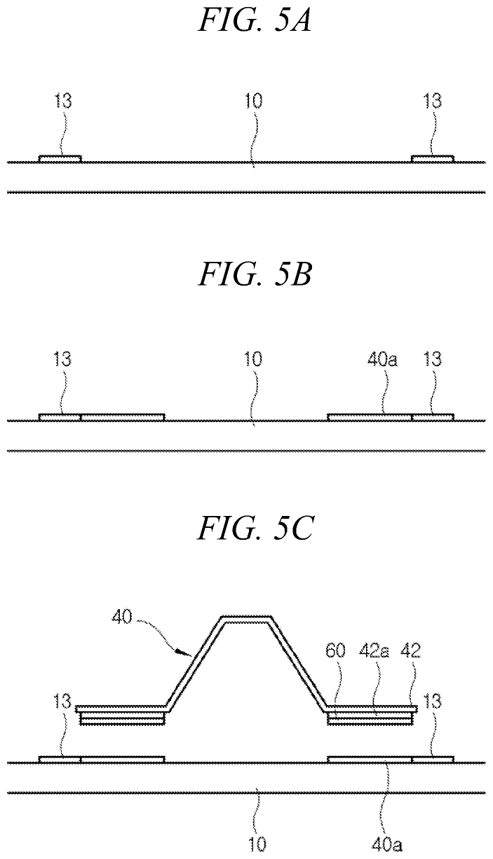

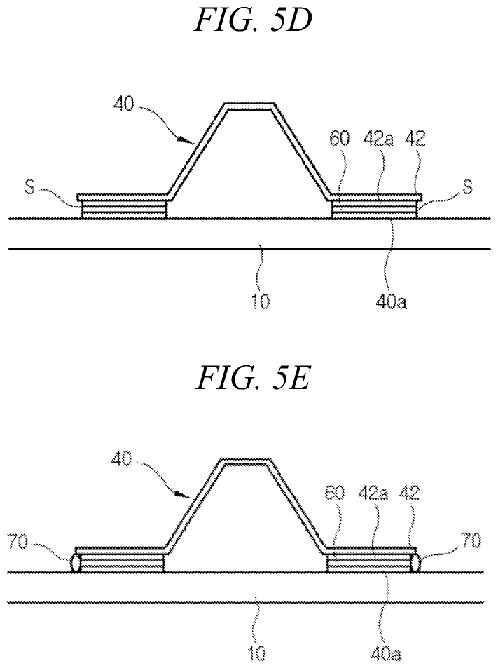

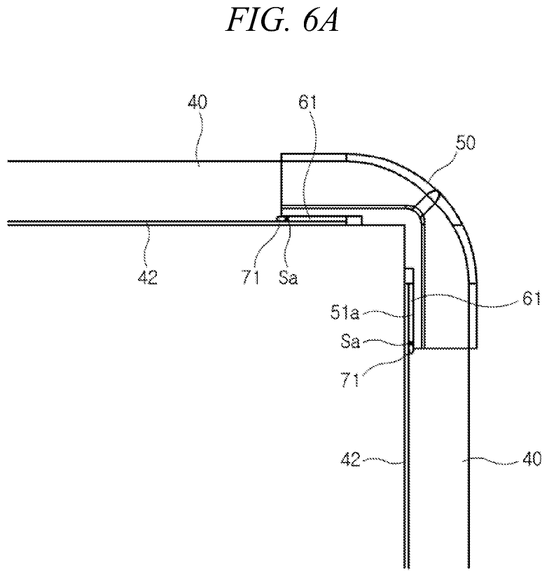

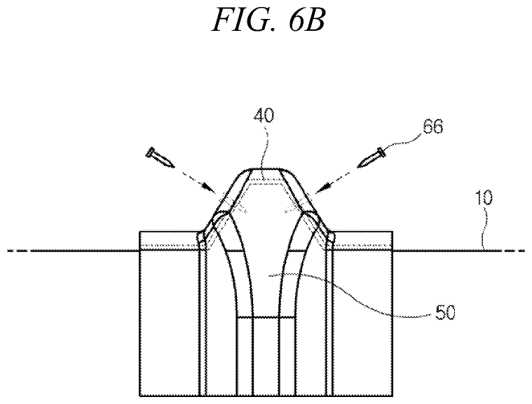

The duct unit 100 constructed as described above is reinforced by a reinforcing method as shown in FIGS. 5A to 5E and FIGS. 6A and 6B.

That is, first, a first process for preparing the duct body 10 equipped with the flanges 11, the four slats 40 and the four angle couplers 50 is performed.

Then, coupling of the slats 40 and the body 10 is performed as described below.

First, a second process for applying a tape 13 to the side of a top surface of the body 10 to which a double-sided tape 60 is to be applied is performed as shown in FIG. 5A.

The reason for applying the tape 13 to the top surface of the body 10 is to enable a primer coating layer 40a to be straightened out in a transverse direction and a longitudinal direction of the body 10 and coated on the top surface of the body 10.

Then, in order to enhance initial adhesion and maintain strong adhesion with respect to the double-sided tape 60 to be applied and also to remove oil components present on a bottom surface of the flat sheet portion 42 of the slat 40 and the top surface of the body 10 to which the slat 40 is to be coupled, a third process for coating a liquid primer along the tape 13 with a brush on the top surface of the body 10 to which the slat 40 is to be coupled to form the primer coating layer 40a thereon as shown in FIG. 5B and coating the primer on the bottom surface of the flat sheet portion 42 of the slat 40 to form a primer coating layer 42a thereon as shown in FIG. 5C is performed.

Thereafter, a fourth process for applying one side of the double-sided tape 60 to the bottom surface of the flat sheet portion 42 of the slat 40 on which the primer coating layer 42a has been formed as shown in FIG. 5C and then applying the other side of the double-sided tape 60 to the top surface of the body 10 on which the primer coating layer 40a has been formed as shown in FIG. 5D is performed.

Then, a fifth process for removing the tape 13 from the top surface of the body 10 as shown in FIG. 5D is performed

Subsequently, a sixth process for injecting a flame retardant silicone adhesive into a gap S between the edge of the flat sheet portion 42 of the slat 40 and the edge of the top surface of the body 10 and hardening the flame retardant silicone adhesive therein to form an injection layer 70 in the gap S as shown in FIG. 5E is performed because the double-sided tape 60 is interposed between the flat sheet portion 42 of the slat 40 and the top surface of the body 10, and, thus, the gap S is formed between the edge of the flat sheet portion 42 of the slat 40 and the edge of the top surface of the body 10. Accordingly, adhesion of the double-sided tape 60 with the flat sheet portion 42 of the slat 40 and the top surface of the body 10 can be enhanced. Also, the flat sheet portion 42 and the top surface of the body 10 are bonded to each other while the gap S is sealed, and, thus, it is possible to suppress the intrusion of foreign substances and also possible to achieve fireproof and waterproof properties.

Then, coupling of the slat 40, the angle coupler 50 and the body 10 is performed as shown in FIGS. 6A and 6B.

That is, a seventh process for applying one side of a double-sided tape 61 to four step portions 51a formed in the pair of female parts 51 of the angle coupler 50 and then applying the other side of the double-sided tape 61 to top surfaces of ends of the pair of flat sheet portions 42 of the two slats 40 adjacent to each other is performed.

Thereafter, an eighth process for injecting a flame retardant silicone adhesive into a gap Sa between the edges of the four step portions 51a formed in the pair of female parts 51 of the angle coupler 50 and the edge of the flat sheet portion 42 of the slat 40 and hardening the flame retardant silicone adhesive therein to form an injection layer 71 in the gap Sa is performed because the double-sided tape 61 is interposed between the four step portions 51a formed in the pair of female parts 51 of the angle coupler 50 and the flat sheet portion 42 of the slat 40, and, thus, the gap Sa is formed between the edges of the four step portions 51a formed in the pair of female parts 51 of the angle coupler 50 and the edge of the flat sheet portion 42 of the slat 40. Accordingly, adhesion of the double-sided tape 61 with the four step portions 51a formed in the pair of female parts 51 of the angle coupler 50 and the flat sheet portion 42 of the slat 40 can be enhanced. Also, the four step portions 51a formed in the pair of female parts 51 of the angle coupler 50 and the flat sheet portion 42 are bonded to each other while the gap Sa is sealed, and, thus, it is possible to suppress the intrusion of foreign substances and also possible to achieve fireproof and waterproof properties. Also, when a not-illustrated insulation material is covered on the outer surfaces of the bodies 10 with the pair of connection flanges 11 interposed therebetween, it is possible to suppress tearing caused by the end of the slat.

Further, if a non-illustrated gap is formed between the L-shaped bump portion 52a of the angle coupler 50 and the body 10 facing the L-shaped bump portion 52a, a flame retardant silicone adhesive is injected into the non-illustrated gap and hardened therein to form the injection layer 71 in the non-illustrated gap, and, thus, the L-shaped bump portion 52a of the angle coupler 50 and the body 10 facing the L-shaped bump portion 52a are bonded to each other while the non-illustrated gap is sealed. Therefore, it is possible to suppress the intrusion of foreign substances and also possible to achieve fireproof and waterproof properties.

Then, a ninth process for driving pieces 66 into regions where the hypotenuses 41a of the equilateral trapezoidal cross-sectional portion 41 of the slat 40 and the female parts 51 of the angle coupler 50 overlap each other is performed to suppress the deviation between the angle coupler 50 and the slat 40.

In the duct unit 100 constructed according to the above-described reinforcing method, four slats 40 are integrally coupled to four sides of the body 10 and thus can sufficiently reinforce the pressure acting on the body 10 and can maintain reinforcement particularly for the pressure applied in a diagonal direction of the body 10. Also, the slats 40 are coupled to the body 10 with an adhesive, and, thus, a gap is not formed between these coupling portions and the efficiency of installation work is improved. Further, if an insulation sheet is covered on the duct to keep the duct warm, ends of the slats 40 are coupled by the angle coupler 50 in a state where the slats 40 protrude at an obtuse angle of inclination from the body 10, and, thus, there is no need to worry about tearing of the insulation sheet and the insulation sheet can keep the body 10 warm well. Also, even if the insulation sheet is formed thick for insulation, the insulation sheet can be in close contact with the body 10 and the slats 40. Therefore, an air layer is not formed between the body 10 coupled to the slats 40 and the insulation sheet, and, thus, it is possible to suppress condensation.

What is claimed is:

1. A duct unit comprising:
a body having a rectangular cross section;
connection flanges provided at both ends of the body;
slats bonded and fixed to outer surfaces of the body by using double-sided tapes without using rivets; and
angle couplers in contact with ends of adjacent two slats of the slats at corners of the body, bonded and fixed to outer surfaces of the ends of the two slats.

2. The duct unit of claim 1,
wherein the slats comprises:
a trapezoidal cross-sectional portion; and
a pair of flat sheet portions extended in opposite directions under a pair of hypotenuses of the trapezoidal cross-sectional portion.

3. The duct unit of claim 2,
wherein the angle couplers comprises:
a pair of female parts stacked on the ends of the two slats to be in contact therewith and bonded and fixed to the ends of the two slats; and
a bent part whose both ends are coupled to the pair of female parts.

4. The duct unit of claim 3,
wherein middle inner side of the bent part has a 90-degree bent surface and middle outer side of the bent part has a bent surface.

5. The duct unit of claim 3,
wherein step portions are formed in bottom surfaces of the pair of female parts to be mounted on the pair of flat sheet portions, and
wherein L-shaped bump portions are formed in bottom surfaces of the bent part to prevent the pair of flat sheet portions from exceeding the L-shaped bump portions.

6. The duct unit of claim 2, further comprising:
primer coating layers formed on top surfaces of the body to which the slat is to be coupled, and formed on bottom surfaces of the flat sheet portions.

7. The duct unit of claim 6,
wherein the double-sided tapes are interposed between the flat sheet portion of the slat and the top surface of the body, one side of the double-sided tapes bonded to the primer coating layers of the flat sheet portions, and the other side of the double-sided tapes bonded to the primer coating layers of the body.

8. The duct unit of claim 7, further comprising:
injection layers in gaps between edges of the flat sheet portions and the top surface of the body, formed by injecting and hardening adhesive therein.

9. The duct unit of claim 5,
wherein the double-sided tapes are interposed between the step portions and the flat sheet portions, one side of the double-sided tapes bonded to the step portions, and the other side of the double-sided tapes bonded to top surfaces of the flat sheet portions.

10. The duct unit of claim 9, further comprising:
injection layers in gaps between edges of the step portions and the top surfaces of the flat sheet portions, formed by injecting and hardening adhesive therein.

11. The duct unit of claim 3, further comprising:
pieces penetrated into regions where the hypotenuses of the trapezoidal cross-sectional portion and the female parts of the angle coupler overlap each other.
